(19) United States
(12) Patent Application Publication
(10) Pub. No.: US 2024/0230352 A1
(43) Pub. Date: Jul. 11, 2024

(54) INFORMATION PROCESSING APPARATUS AND METHOD

(71) Applicant: TOYOTA JIDOSHA KABUSHIKI KAISHA, Aichi-ken (JP)

(72) Inventor: Takeshi HORI, Tokyo-to (JP)

(21) Appl. No.: 18/398,157

(22) Filed: Dec. 28, 2023

(30) Foreign Application Priority Data
Jan. 5, 2023 (JP) 2023-000575

(51) Int. Cl. G01C 21/34; G01C 21/36

(52) U.S. Cl. CPC G01C 21/3461; G01C 21/3691

(57) ABSTRACT

An information processing apparatus includes a processor configured to acquire, for a first area including a range from a departure point to a destination, first information related to weather and second information related to a point having lower altitude above sea level than a surrounding area, and acquire, based on the first information and the second information on the first area, a first route that is a route from the departure point to the destination and that avoids a point that may be flooded in the event of a water disaster, and output the first route. The processor acquires the first route for each of the one or more future time points from the departure time.

### CROSS REFERENCE TO RELATED APPLICATION

This application claims the benefit of Japanese Patent Application No. 2023-000575, filed on Jan. 5, 2023, which is hereby incorporated by reference herein in its entirety.

### BACKGROUND

### Technical Field

The present disclosure relates to a route proposal.

### Description of the Related Art

A prediction device for acquiring a planned scheduled travel route including height information on which an electric vehicle is scheduled to travel is disclosed (for example, Patent 1).

### CITATION LIST

### Patent Document

[Patent Document 1] Japanese Patent Laid Open No. 2022-129116

One aspect of the disclosure is to provide an information processing apparatus and a method capable of providing a safe route in the event of a water disaster.

### SUMMARY

An aspect of the present disclosure is an information processing apparatus including:
a processor configured to acquire, for a first area including a range from a departure point to a destination, first information related to weather and second information related to a point having lower altitude above sea level than a surrounding area;
acquire, based on the first information and the second information on the first area, a first route from the departure point to the destination, the first route avoiding a point that may be flooded in the event of a water disaster; and
output the first route.

Another aspect of the present disclosure is a method executed by a computer including:
acquiring, for a first area including a range from a departure point to a destination, first information related to weather and second information related to a point having lower altitude above sea level than a surrounding area;
acquiring, based on the first information and the second information on the first area, a first route from the departure point to the destination, the first route avoiding a point that may be flooded in the event of a water disaster; and
outputting the first route.

According to one aspect of the present disclosure, it is possible to provide a safe route in the event of a water disaster.

### BRIEF DESCRIPTION OF DRAWINGS

FIG. 1 is a diagram illustrating an example of the configuration of a route proposal system according to the first embodiment;

FIG. 2 is a diagram illustrating an example of a hardware configuration of the server and the in-vehicle device;

FIG. 3 is a diagram illustrating an example of a functional configuration of the server;

FIG. 4 is an example of a flowchart of the route search process of the server;

FIG. 5 is an example of a route proposed at the departure point (current time); and

FIG. 6 is an example of a route proposed at a time point 5 minutes after the departure time.

### DESCRIPTION OF THE EMBODIMENTS

In recent years, guerrilla torrential rain with a large amount of precipitation in a short period of time has often occurred. If a large amount of rain falls in a short period of time, roads with lower altitude above sea level than the surrounding area may be flooded. It is difficult to pass on flooded roads, whether it is a vehicle or a pedestrian. Therefore, in the event of a water disaster such as a guerrilla heavy rain, it is desirable to provide a route that takes into account flooding.

In view of the above problem, one aspect of the present disclosure provides a route in consideration of a road that is flooded when a flood occurs. More specifically, one aspect of the present disclosure is an information processing apparatus including a processor. The processor may be configured to acquire, for a first area including a range from a departure point to a destination, first information related to weather and second information related to a point having lower altitude above sea level than a surrounding area. The processor may acquire and output, based on the first information and the second information about the first area, a first route that is a route from the departure point to the destination and that avoids a point that may be flooded when a water disaster occurs.

The information processing apparatus may be, for example, a server, an in-vehicle device, or a user terminal. The in-vehicle device may be, for example, a car navigation device, a data communication device (DCM), or the like. The user terminal may be, for example, a smartphone, a personal computer (PC), a tablet terminal, or the like. The user terminal may include an in-vehicle device. The processor may be, for example, a processor such as a central processing unit (CPU) or a digital signal processor (DSP).

The area may be an area used in information related to weather. For example, when information related to weather is measured on a municipal basis, the area may coincide with the boundaries of the municipality. The area used in the information related to weather may differ depending on the organization that measures the information related to weather and the particle size to be measured. The range from the departure point to the destination may be, for example, a range including a line segment connecting the departure point and the destination, or a range including a shortest route from the departure point to the destination. For example, when the departure point and the destination exist in the same area, the area including the departure point and the destination may become the first area. For example, when the departure point and the destination are located in different areas, the area including the departure point, the area including the destination, and the area existing between the departure point and the destination may correspond to the first area.

The first information may include, for example, weather forecast information, precipitation information, rain cloud radar information, and warnings and advisories related to rain. The first information may be obtained from, for example, a server providing information related to weather, or may be obtained by searching the web for information that is generally available to the public. The second information related to the point having lower altitude above sea level than the surrounding area may include, for example, hazard maps created by each local government, contour line and altitude above sea level information of the map, information on roads with a possibility of flooding identified from the analysis result of captured images of in-vehicle cameras, information on roads with a possibility of flooding surveyed by surveyors, and information on roads with a track record of flooding extracted from information in big data such as SNS (Social Networking Service). The second information may be acquired in advance and stored in the storage, or may be acquired from a predetermined server. Water disasters may include, for example, guerrilla downpours, rainfall due to linear precipitation bands, floods, river flooding, storm surges, and tsunamis. Elevation may be used instead of altitude above sea level. That is, the second information may be information about a point at which the altitude is lower than the surrounding area.

According to one aspect of the present disclosure, it is possible to propose a route to avoid a point where there is a possibility of flooding in the event of a water disaster in consideration of flooding in the event of a water disaster.

In one aspect of the present disclosure, the processor may acquire the first route for each of one or more future time points from departure time. The future time points are, for example, 5 minutes, 10 minutes, 15 minutes, 30 minutes, 1 hour or the like after a time point of searching for a route. For example, if rainfall continues for a long time, the amount of rain accumulating in low-lying areas will increase over time, so there is a possibility that the number of flooded roads will increase over time. On the other hand, if the rain stops falling in a short time, for example, the accumulated rain may be drained, the flooding of roads may be eliminated, and the number of flooded roads may decrease. Therefore, for example, the point of flooding may be different after 5 minutes and after 30 minutes, and the proposed route will also be different. According to one aspect of the present disclosure, it is possible to propose a route according to the state of flooding forecasted at a future time point.

One or more future time points from the departure time at which the first route is acquired may be determined based on a way of transportation and the distance from the departure point to the destination. For example, when the way of transportation is walking and the distance from the departure point to the destination is a distance of 10 minutes walking, the first route one hour after the departure time is unlikely to be used. Therefore, in this case, for example, the time point in the future from the departure time at which the first route is acquired may be 5 minutes, 10 minutes, and 15 minutes later. For example, when the way of transportation is walking and the distance from the departure point to the destination is a distance that takes one hour for the vehicle, the future time point at which the first route is acquired may be 5 minutes, 10 minutes, 15 minutes, 30 minutes, and 1 hour later. Therefore, it is possible to suppress acquiring a first route that is unlikely to be used based on the way of transportation and the distance from the departure point to the destination, and it is possible to reduce the processing load of the information processing apparatus.

In the following, embodiments of the present disclosure will be described with reference to the drawings. The configuration of the embodiments described below are examples, and the present disclosure is not limited to the configuration of the embodiments.

### First Embodiment

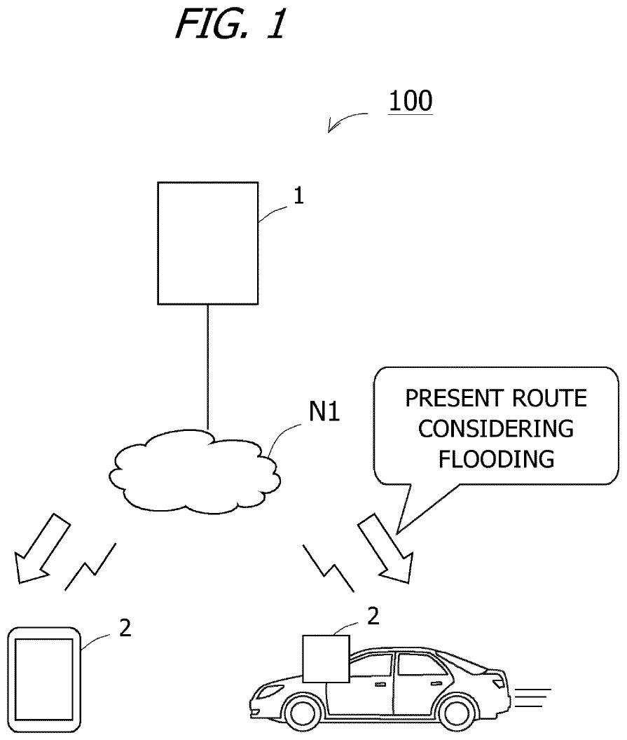

FIG. 1 is a diagram illustrating an example of the configuration of a route proposal system 100 according to the first embodiment. The route proposal system 100 according to the first embodiment is a system that proposes a route in consideration of flooding in the event of a water disaster. The route proposal system 100 includes a server 1 and a user terminal 2. The user terminal 2 includes an in-vehicle device, a smartphone, a tablet terminal, a PC, and the like. Hereinafter, the user terminal 2 will be described assuming an in-vehicle device.

The server 1 and the in-vehicle device 2 mounted on the vehicle are connected to the network N 1 and can communicate with each other through the network N1. The network N1 is, for example, a public network such as the Internet.

The server 1 holds flood prediction information on points at which the altitude above sea level is lower than a surrounding area. The flood prediction information includes, for example, hazard maps issued by each local government, contour line and altitude above sea level information on maps, information on roads with a possibility of flooding identified from analysis results of captured images of in-vehicle cameras, information on roads with a possibility of flooding surveyed by surveyors, and information on roads with a proven track record of flooding extracted from information in big data such as SNS.

The server 1 receives a route request from the in-vehicle device 2. In addition to the route request, information such as a departure point, a destination, and a way of transportation is also received from the in-vehicle device 2. When the server 1 receives the route request, the server 1 acquires the information related to weather and the flood prediction information, for the area including the range from the departure point to the destination. Based on these information, when there is a possibility of flooding, the server 1 acquires a route to avoid the road where there is a possibility of flooding, and transmits the route to the in-vehicle device 2. Further, the server 1 acquires routes to avoid a road that may be flooded for a plurality of future points in time, such as 5 minutes later, 10 minutes later, and the like, depending on the way of transportation and the distance from the departure point to the destination, and transmits the routes to the in-vehicle device 2.

According to the first embodiment, it is possible to propose to the user a route avoiding roads that may be flooded during rainfall. The information related to the weather is an example of the “first information”. The flood prediction information is an example of the “second information”.

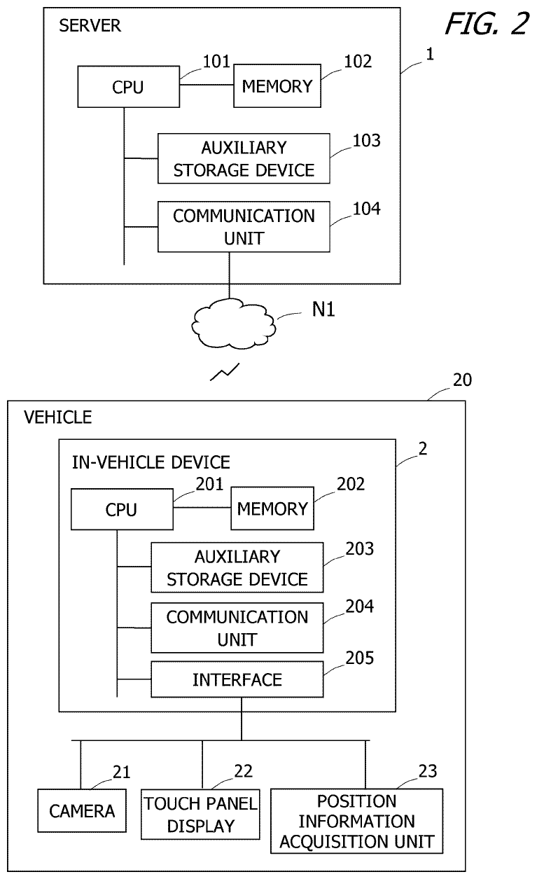

FIG. 2 is a diagram illustrating an example of a hardware configuration of the server 1 and the in-vehicle device 2. The server 1 includes a CPU 101, a memory 102, an auxiliary storage device 103, and a communication unit 104 as hardware configurations. The auxiliary storage device 103 is, for example, a hard disk drive (HDD), a solid state drive (SSD), and the like. The programs held in the auxiliary storage device 103 include, for example, an OS (Operation System), a plurality of other programs, and the like. The memory 102 includes, for example, a semiconductor memory such as a ROM (Read Only Memory) and a RAM (Random Access Memory). The memory 102 and the auxiliary storage device 103 are examples of computer-readable recording media, respectively.

The CPU 101 loads the OS and various other programs held in the auxiliary storage device 103 into the memory 102 to execute various processes. The CPU 101 is not limited to one, and may include a plurality of CPUs. The CPU 101 is an example of a “processor”.

The communication unit 104 is a module, for example, such as a LAN (Local Area Network) card and an optical module, that connects a network cable and comprises a signal processing circuit. The communication unit 104 is not limited to a circuit that can be connected to a wired network, and may be a wireless signal processing circuit that can process wireless signals of a wireless communication network such as WiFi.

Next, in FIG. 2, among the configurations of the vehicle 20, components related to the processing of the route proposal system 100 are extracted and illustrated, and the configurations of the vehicle 20 are not limited to those illustrated in FIG. 2. The vehicle 20 comprises an in-vehicle device 2, a camera 21, a touch panel display 22, and a position information acquisition unit 23. These components are connected by, for example, a CAN (Controller Area Network) network and an in-vehicle network such as an in-vehicle Ethernet.

The camera 21 is, for example, a camera used in a drive recorder mounted on the vehicle 20. The camera 21 is installed so that the periphery of the vehicle 20 is an imaging range. The camera 21 is not limited to one, and may include a plurality of cameras. The touch panel display 22 receives a user operation and outputs a result of processing according to the user operation. The position information acquisition unit 23 is, for example, a GPS (Global Positioning System) receiver. The position information acquisition unit 23 acquires the position information of the vehicle 20 in a predetermined period. The period during which the position information acquisition unit 23 acquires the position information is set, for example, between 0.1 seconds and 1 second.

In the first embodiment, the in-vehicle device 2 receives input of the operation for the route request through the touch panel display 22, and transmits the route request to the server 1. Along with the input of the operation for the route request, the departure point and the destination are also input. When there is no input of the departure point, the current position indicated by the position information acquired by the position information acquisition unit 23 is used as the departure point. Together with the route request, the in-vehicle device 2 transmits, for example, a departure point, a destination, and a “vehicle” as a way of transportation. In addition, information on the time such as the departure time or the arrival time may also be transmitted to the server 1 together with the route request.

The in-vehicle device 2 is, for example, a car navigation system, a data communication device (DCM), or the like. In FIG. 2, the in-vehicle device 2 will be described assuming that it is a car navigation system. The in-vehicle device 2 includes a CPU 201, a memory 202, an auxiliary storage device 203, a communication unit 204, and an interface 205 as hardware configurations. The CPU 201, the memory 202, and the auxiliary storage device 203 are the same as the CPU 101, the memory 102, and the auxiliary storage device 103, respectively.

The communication unit 204 communicates with an external device based on, for example, a mobile communication method such as 5G, 6G, and 4G, Wi-Fi, or a wireless communication method such as Dedicated Short Range Communications (DSRC). The interface 205 is an interface for connecting to an in-vehicle network. The hardware configuration of the server 1 and the vehicle 20 is not limited to the configuration illustrated in FIG. 2

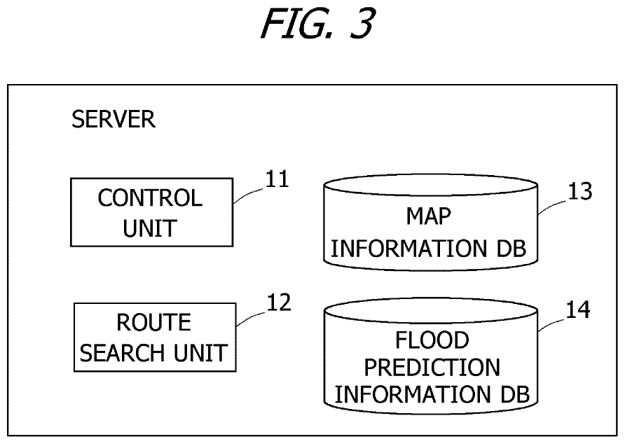

FIG. 3 is a diagram illustrating an example of a functional configuration of the server 1. The server 1 includes a control unit 11, a route search unit 12, a map information DB 13, and a flood prediction information DB 14 as functional configurations. The functions of these functional components are each achieved by executing a predetermined program.

The map information DB 13 and the flood prediction information DB 14 are created in the storage area of the auxiliary storage device 103. The map information DB 13 holds map information. The flood prediction information DB 14 holds the flood prediction information. The flood prediction information includes, for example, position information of a point where altitude above sea level is lower than the surrounding area, altitude above sea level of the point, and information on the height difference with the surrounding area. In addition to the above information, the flood prediction information may include, for example, information such as the presence or absence of flooding and the amount of precipitation at the time of flooding as the history information of flooding. Precipitation is the amount of precipitation per unit time. The unit time is, for example, 1 hour, 12 hours, or 1 day. Hereinafter, in the first embodiment, the amount of precipitation refers to the amount of precipitation per hour.

The control unit 11 may analyze, for example, in a predetermined period, a hazard map issued by each local government, contour line and altitude above sea level information of the map, captured images of the vehicle-mounted cameras of a plurality of vehicles, information on roads with a possibility of flooding surveyed by surveyors, and big data such as SNS, and may acquire flood prediction information including the above information. Alternatively, the flood prediction information may be a hazard map issued by each local government, contour line and altitude above sea level information of the map, images captured by the on-board cameras of a plurality of vehicles, information on roads with a possibility of flooding surveyed by surveyors, and big data such as SNS, itself.

Further, based on the flood prediction information, the control unit 11 may hold, for example, at each point, the relationship between the altitude above sea level, the height difference with the surrounding area, the amount of precipitation, the type of warning and cautionary notice, and the presence or absence of the occurrence of flood in a table, a function, or a learned machine learning model, etc., and predict the occurrence of flood at each point. For example, when the learned machine learning model is used, the control unit 11 causes the learned machine learning model to learn the flood history information as learning data. The control unit 11 inputs the altitude above sea level, the height difference from the surrounding area, and the predicted precipitation amount at each point to the learned machine learning model, and acquires the probability of occurrence of flooding at the point as an output. When the probability of occurrence of flooding at the point acquired as an output of the learned machine learning model is equal to or greater than a predetermined threshold value, the control unit 11 identifies the point as a point at which flooding is predicted.

Next, the control unit 11 receives a route request from the in-vehicle device 2. Along with the route request from the in-vehicle device 2, information such as the departure point, the destination, and the way of transportation is also received. The information received with the route request is not limited thereto, and information such as a relay point, departure time, arrival time, etc. designated by the user may also be received. When the departure time, the arrival time, or the like is not designated, the control unit 11 uses the current time as the departure time.

When the control unit 11 receives the route request from the in-vehicle device 2, the control unit 11 acquires the information related to weather and the flood prediction information for one or more target areas including the range from the departure point to the destination. An area is an area used for measuring information related to weather. When the departure point and the destination are included in a different area, the target area is an area including the departure point, an area including the destination, and an area existing between the departure point and the destination. The target area is an example of the “first area”.

The control unit 11 may acquire information on the weather in the target area from, for example, an external server that provides information on the weather, or may search and acquire the Internet. The information on the weather includes, for example, information on weather forecasts, predicted precipitation, rain cloud radars, and the like in each time zone from the current time to a predetermined period. If the departure time or the arrival time is designated, information on the weather from the departure time to a predetermined period or from the arrival time to a predetermined period may be acquired along with the route request. The period of information on the weather is, for example, a period set between one hour and one day. Further, the control unit 11 acquires flood prediction information for the target area from the map information DB 13. The flood prediction information for the target area is flood prediction information including points at which the altitude above sea level is lower than the surrounding area and which are included in the target area.

Based on the information related to weather and the flood prediction information for the target area, the control unit 11 determines the point at which the flood is predicted when the flood is predicted, and acquires a route from the departure point to the destination so as to avoid the point at which the flood is predicted. Hereinafter, a route that avoids a point where flooding is predicted is referred to as a flood avoidance route. The control unit 11 determines a point at which flooding is predicted, for example, by using a table, a function, or a learned machine learning model or the like that indicates the relationship between (A) altitude above sea level, height difference from the surrounding area, precipitation, and an alarm and a cautionary notice, and (B) the presence or absence of flooding, at each point.

The flood avoidance route may be obtained as follows, for example. First, the control unit 11 requests the route search unit 12 to acquire the route from the departure point to the destination. The control unit 11 notifies the route search unit 12 of the way of transportation in addition to the departure point and the destination. When a relay point is designates by the user, the control unit 11 also notifies the route search unit 12 of information on the relay point. The route search unit 12 searches for a route of the shortest distance, for example, according to the way of transportation. The ways of transportation include, for example, a vehicle, a motorcycle, a bicycle, and walking.

The control unit 11 determines whether or not a point at which flooding is predicted is included in the route acquired from the route search unit 12. When a point at which flooding is predicted is included on the route acquired from the route search unit 12, the control unit 11 modifies a part of the route so as to rotate the point, and acquires a flood avoidance route.

As another method for acquiring a flood avoidance route, the control unit 11 may instruct the route search unit 12 to create a route avoiding a point where flooding is predicted, and cause the route search unit 12 to search for the flood avoidance route.

Further, the control unit 11 acquires a flood avoidance route for a plurality of future time points in addition to the departure time according to the distance between the departure point and the destination and the way of transportation. This is because the prediction of points to be flooded changes over time.

The future time points at which the flood avoidance route is acquired may be determined, for example, at predetermined time intervals according to the way of transportation. For example, when the way of transportation is walking, a flood avoidance route may be acquired for each time point every 5 minutes from the departure time. For example, when the way of transportation is a vehicle, a flood avoidance route may be acquired for each time point every 10 minutes from the departure time. Note that the control unit 11 may determine the future time points for acquiring the flood avoidance route, limited to the time points included within the travel time from the departure point to the destination.

The travel time from the departure point to the destination may be estimated by the control unit 11 from the distance between the departure point and the destination and the way of transportation, or may be acquired from the route search unit 12 together with the route from the departure point to the destination. When the control unit 11 estimates the travel time from the departure point to the destination, the distance between the departure point and the destination may be a linear distance on the map. Further, the travel time can be estimated by using the travel speed assumed according to the way of transportation. For example, in the case of walking, a value between 50 meters per minute and 100 meters per minute may be assumed. For example, in the case of a vehicle, a speed of 20 kilometers to 60 kilometers per hour may be assumed.

In addition to the above, the future time point at which the flood avoidance route is acquired may be determined, for example, based on the estimated travel time from the departure point to the destination. For example, a time point at which the flood avoidance route is acquired may be set in advance according to the length of the travel time. For example, when the travel time is less than 10 minutes, the time points 5 minutes and 10 minutes after the departure time may be set. For example, when the travel time is 10 minutes equal to or greater than and less than 30 minutes, the time points after 5 minutes, 10 minutes, 15 minutes, 20 minutes, and 30 minutes from the departure time may be set. For example, when the travel time is 30 minutes equal to or greater than and less than 1 hour, the time points after 5 minutes, 10 minutes, 15 minutes, 30 minutes, 45 minutes, and 1 hour from the departure time may be set. For example, when the travel time is 1 hour equal to or greater than, the time points after 10 minutes, 20 minutes, 30 minutes, 1 hour, from the departure time, and after that, every 30 minutes may be set. Note that the setting of the time points at which the flood avoidance route is determined according to the travel time is not limited to the above example.

The control unit 11 may determine a plurality of flood avoidance routes for each future time point. The control unit 11 transmits the flood avoidance routes for each of the departure time point and the future time points from the departure time point to the in-vehicle device 2.

In accordance with the instruction from the control unit 11, the route search unit 12 refers to the map information DB 13 and searches for a route from the departure point to the destination according to the way of transportation. The route search method by the route search unit 12 is not limited to a specific method, and any of the well-known methods may be used. The route search unit 12 searches for a route, for example, so that the travel time is shorter or the travel distance is shortest. The route search unit 12 acquires a route passing through the designated relay point, if any, from the departure point to the destination point. For example, since there are roads and the like that cannot be physically or legally passed by the vehicle, the route search unit 12 searches for a route in consideration of them and the way of transportation. Further, when the route search unit 12 is instructed to acquire a plurality of routes from the control unit 11, the route search unit 12 may acquire, for example, a predetermined number of routes from the upper ranks in the order in which the travel time is short, and output the routes to the control unit 11. Note that the functional configuration of the server 1 is not limited to the example illustrated in FIG. 3.

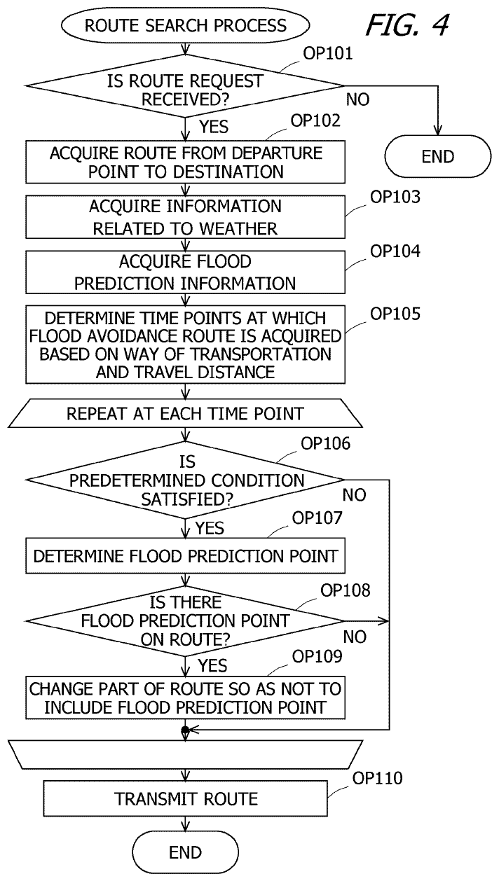

FIG. 4 is an example of a flowchart of the route search process of the server 1. The process illustrated in FIG. 4 is repeatedly executed in a predetermined period. The main performer of the processing in FIG. 4 is the CPU 101 of the server 1, but for convenience, the functional components will be described as a main performer.

In OP101, the control unit 11 determines whether or not a route request has been received from the in-vehicle device 2. When the route request is received from the in-vehicle device 2 (OP101: YES), the process proceeds to OP102. When the route request is not received from the in-vehicle device 2 (OP101: NO), the process illustrated in FIG. 4 ends.

In the OP 102, the control unit 11 instructs the route search unit 12 to acquire a route from a departure point to a destination point from the route search unit 12. In the OP103, the control unit 11 acquires information related to weather for a target area including the range from the departure point to the destination. When information on the point where flooding has already occurred is disclosed along with information related to weather, the information on the point where flooding has already occurred may also be acquired.

In the OP 104, the control unit 11 acquires flood prediction information for the target area from the flood prediction information DB 14. In the OP105, the control unit 11 determines one or more future time points at which the flood avoidance route is acquired based on the way of transportation and the distance from the departure point to the destination.

The processes from OP106 to OP108 are executed for each of the departure point and the time points determined in OP105. In the OP106, the control unit 11 determines whether or not a predetermined condition for predicting the occurrence of flooding in the target area is satisfied based on the information related to weather in the time zone in which the target time point is included. The predetermined condition is, for example, that the cumulative value of the amount of precipitation from a predetermined time before the target time point is equal to or greater than a predetermined threshold value, that the predicted amount of precipitation per unit time in the time zone including the target time point is equal to or greater than the predetermined threshold value, that an alarm or a warning regarding a water disaster has been issued, and the like, and when at least one of these is satisfied, the OP106 is an affirmative determination.

When the predetermined condition is satisfied (OP106: YES), the process proceeds to OP107. When the predetermined condition is not satisfied (OP 106: NO), since the possibility of occurrence of flooding is low, the control unit 11 determinates not to perform acquisition of the flood avoidance route, and holds the route acquired in OP 102 as the route to be presented to the user. In this case, the process proceeds to the next time point, or if the process for all time points has been completed, the process proceeds to OP110. For example, when it is not raining, the cumulative value of the predicted precipitation amount from a predetermined time before the target time point is close to 0, so the possibility of occurrence of flooding is low, and the OP106 is a negative determination.

In OP107, the control unit 11 determines a point at which flooding is predicted in the target area at the target time point based on the information related to weather and the flood prediction information in the target area. Hereinafter, the point where the flood is predicted is referred to as the flood prediction point. The method for determining the flood prediction point is as described above.

In the OP108, the control unit 11 determines whether or not there is a flood prediction point or a point at which flood has already occurred on the route acquired in the OP102. If there is a flood prediction point or a point where flooding has already occurred on the route (OP108: YES), the process proceeds to OP109. If there is no flood prediction point and no point where flood has already occurred on the route (OP 108: NO), the process proceeds to a process for the next time point, or if the processing for all time points has been completed, the process proceeds to OP 110.

In the OP 109, the control unit 11 changes a part of the route so as to rotate the flood prediction point on the route, and acquires the flood avoidance route. After that, if the process proceeds to a process for the next time point or the processing for all time points has been completed, the process proceeds to OP110.

In the OP 110, the control unit 11 transmits information on the route to the in-vehicle device 2. For example, the routes or the flood avoidance route at each time point, the position information of the flood prediction point, and the information related to weather at each time point may be transmitted. Thereafter, the process illustrated in FIG. 4 ends. The route search process of the server 1 is not limited to the process illustrated in FIG. 4

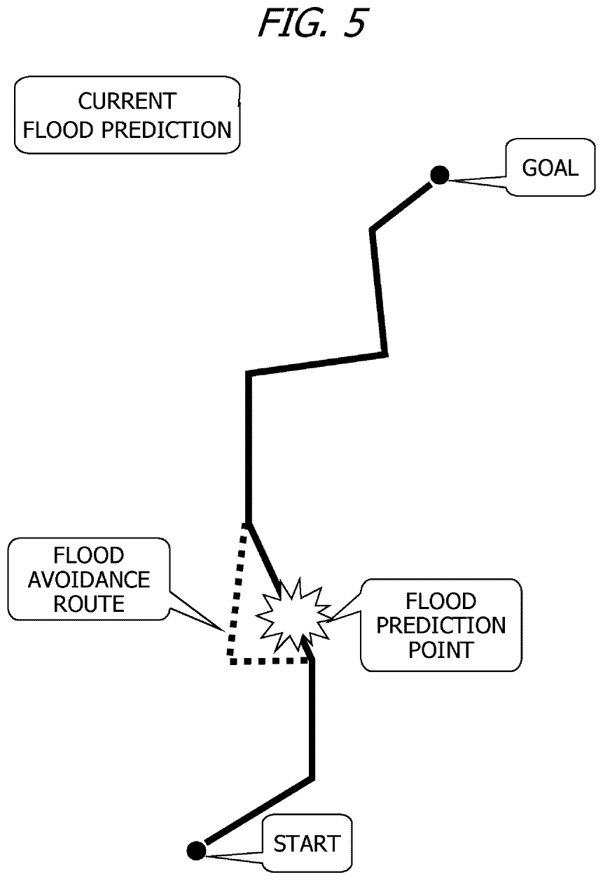

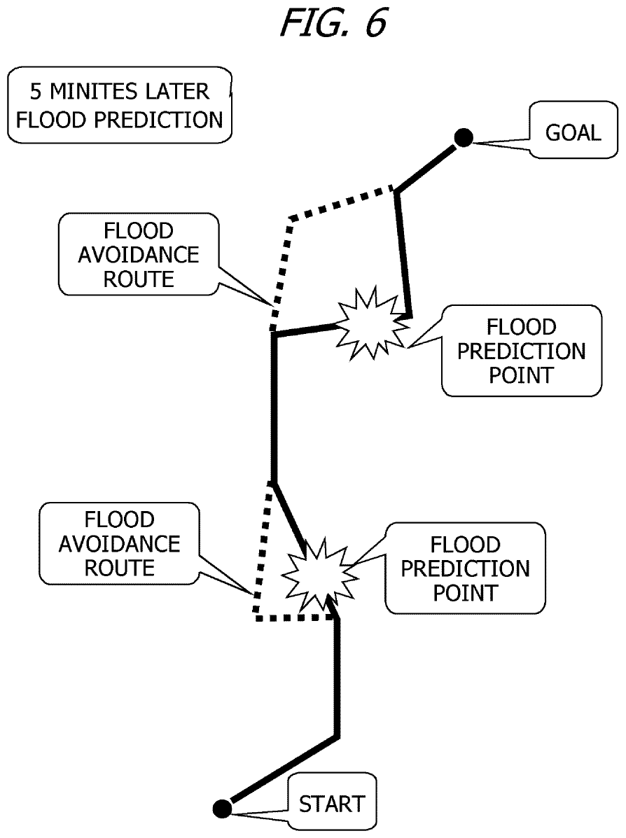

FIG. 5 and FIG. 6 are examples of a display of a route in consideration of flooding. FIG. 5 is an example of a route proposed at the departure point (current time). FIG. 6 is an example of a route proposed at a time point 5 minutes after the departure time. The solid line indicates the route from the departure point to the destination without considering flooding. The dashed line indicates the part of the flood avoidance route that circumvents the flood prediction point. In the route after 5 minutes illustrated in FIG. 6, the number of flood prediction points has increased due to rainfall, and a flood avoidance route different from the route illustrated in FIG. 5 is illustrated. The display aspect of the route considering the flooding is not limited to the examples illustrated in FIG. 5 and FIG. 6. For example, the route at each time point may be represented on a single screen.

### Operations and Effects of the First Embodiment

According to the first embodiment, it is possible to present a route considering flooding in the event of a water disaster to the user. Therefore, the user can travel in a safe route even in the event of a water disaster. In the first embodiment, in addition to the departure time point, a route that takes into account flooding from the departure time point to the future time point is also presented to the user. This allows the user to change the departure time, for example, in order to use a safer route.

### Other Embodiments

The embodiments described above are examples, and the present disclosure may be changed and carried out as appropriate without departing from the gist of the present disclosure.

In the first embodiment, the server 1 performs route search in consideration of flooding. The user terminal may perform the same processing as the server 1 on its own. In this case, the user terminal holds a program for executing the process illustrated in FIG. 4 in the auxiliary storage device.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising:
a processor configured to acquire, for a first area including a range from a departure point to a destination, first information related to weather and second information related to a point having lower altitude above sea level than a surrounding area;
acquire, based on the first information and the second information on the first area, a first route from the departure point to the destination, the first route avoiding a point that may be flooded in the event of a water disaster; and
output the first route.

2. The information processing apparatus according to claim 1, wherein
the processor is configured to acquire the first route when the first information on the first area satisfies a predetermined condition indicating a weather in which there is a possibility of occurrence of flooding.

3. The information processing apparatus according to claim 1, wherein
the processor is configured to acquire the first route for each of one or more future time points from the departure time.

4. The information processing apparatus according to claim 3, wherein
the processor is configured to determine the one or more future time points from the departure time based on a way of transportation and distance from the departure point to the destination.

5. A method executed by a computer comprising:
acquiring, for a first area including a range from a departure point to a destination, first information related to weather and second information related to a point having lower altitude above sea level than a surrounding area;
acquiring, based on the first information and the second information on the first area, a first route from the departure point to the destination, the first route avoiding a point that may be flooded in the event of a water disaster; and
outputting the first route.
